(19) United States
(12) Patent Application Publication
(10) Pub. No.: US 2024/0428323 A1
(43) Pub. Date: Dec. 26, 2024

(54) NFT-BASED RENTAL CERTIFICATE FOR RENTAL HISTORY

(71) Applicant: Datacurve, Inc., Los Altos, CA (US)

(72) Inventors: Rakesh Ramde, Los Altos, CA (US); Amanjyot Singh Johar, Sunnyvale, CA (US)

(73) Assignee: Datacurve, Inc., Los Altos, CA (US)

(21) Appl. No.: 18/669,018

(22) Filed: May 20, 2024

Related U.S. Application Data
(60) Provisional application No. 63/467,676, filed on May 19, 2023.

(51) Int. Cl. G06Q 30/0645; G06Q 20/08; G06Q 20/36; G06Q 20/38; H04L 9/00

(52) U.S. Cl. CPC G06Q 30/0645; G06Q 20/0855; G06Q 20/36; G06Q 20/382; H04L 9/50; G06Q 2220/00; H04L 2209/56

(57) ABSTRACT

A renter establishes an NFT token through an app to include rental history. The rental history is updated via automated data reporting service processes periodically across one or more addresses of the renter on the NFT token. An NFT engine mints NFT tokens and processes and secures transactions. The NET token can be accessed by a third party or automated data reporting service processes to review and use embedded data for rental verifications, advertisements, and other purposes.

### CROSS-REFERENCE TO RELATED APPLICATIONS

The invention claims priority under 35 USC 119(e) to 63/467,676, entitled NFT-BASED RENTAL CERTIFICATE FOR RENTAL HISTORY, and filed May 19, 2023, by Ramde et al., the contents of which are hereby incorporated in its entirety.

### FIELD OF THE INVENTION

The invention relates generally to computer networks and computer software, and more specifically, to capturing transaction-level rental history for a particular renter that is verifiable and reliable using a non-fungible cryptographic token (NFT) based rental certificate.

### BACKGROUND

For renters or tenants who pay to rent apartments and houses, there is no independently reliable or verifiable record of whether they pay their rent on time or are good tenants in a way that is transparent and accessible to other parties such as other landlords or retail enterprises. Usually, rental payment history is limited only between the tenant and the current landlord. While it may be evidenced on a banking or other payment statement, a bank statement may include other private information such as unrelated payments not intended to be shared and there is no convenient way to easily, transparently and verifiably share information in a restricted manner. Moreover, if the tenant builds up a good (or bad) record of paying rent on time or being a good tenant and taking care of the place, there is an absence of an adequate platform for capturing this information. Consequently, as tenants or renters move to subsequent rental locations, there is no clear way of verifying to new apartment owners, landlords, roommates and the like that they have a good track record of paying on time as a tenant, were taking good care of their previous rental, or were good roommates, etc.

Currently, if a renter wants to rent an apartment they go to a new unit or go online to fill out an application form. The prospective landlord then has to reach out and call previous rental owners to verify and ask for rental history. This is an inconvenience, and oftentimes previous apartment owners are reluctant to share that information since they no longer have an incentive or obligation to do so given that the previous relationship is over. Also, the landlord (or roommate) can pay to run a third party credit check that may contain inaccuracies or reflect payment histories that don't provide insights as to how good a prospective renter may be as a tenant in terms of paying rent on time, leaving a property in good condition, etc.

Therefore, what is needed is a robust technique that captures a rental history of a particular renter on a blockchain that is verifiable and reliable.

### SUMMARY

To meet the above-described needs, methods, computer program products, and systems for capturing rental history for renters that is verifiable and reliable, and where the renters or other parties can create and leverage rental history for services, future rentals, marketing opportunities and other benefits.

In one embodiment, a renter a private key/wallet address pair associated with a specific renter is created to interact with the system, wherein the renter private key/wallet address pair is associated with a specific blockchain. An entity private key/wallet address pair associated with a specific landlord to interact with the smart contract is also created and at least a portion of the renter data associated with the specific renter on the blockchain is stored.

In another embodiment, a smart contract is created for renter data associated with a relationship between a specific renter and a specific landlord in a rental history database. A new NFT in a series is generated on the specific blockchain according to new rental data using the smart contract and authorized by the entity private key/wallet key pair of the specific renter or the specific landlord to activate the rental history.

Advantageously, a user's rental history can be generated by a platform in a way that captures how well a user is paying their rent and how good a tenant they are. This platform can also then be used by the landlord or prospective landlord to verify or qualify a particular tenant. Landlords have an incentive to rent to renters that pay on time and that take care of their unit or can be good roommates (if applicable). Such a system can also surface opportunities to users such as based incentives to the user, permissions set by a user or actions performed by the user. In addition, connected devices in homes and rental units can provide information about the renter's use of utilities such as electricity, water etc. This data can be gathered using connected thermostats, or water meters, etc. This data can then be made actionable by including additional incentives (by the renter or third parties) to make an available unit attractive to the renter based on their energy consumption.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for capturing rental history of a particular renter that is verifiable and reliable, and where the renter can create and leverage their rental history, according to an embodiment.

FIG. 2 a high-level of the NFT Engine and its components, according to an embodiment.

FIG. 3 illustrates an exemplary high level architectural view of a sports NFT marketplace and applications, according to an embodiment.

FIG. 4 is a block diagram illustrating the elements of the LogicWare with artificial intelligence, blockchain and Web3 interfaces, according to an embodiment.

FIG. 5 illustrates the use of verified credentials (VCs) for authentication into the ecosystem of applications for access control or user onboarding features, according to an embodiment.

FIG. 6 is a more detailed block diagram illustrating a rental certificate module of the system of FIG. 1, according to an embodiment.

FIG. 7 is a high-level flow diagram illustrating a method for capturing rental history of a particular renter that is verifiable and reliable, according to one embodiment.

FIG. 8 is a more detailed flow diagram illustrating an alternative method for capturing rental history of a particular renter that is verifiable and reliable, according to one embodiment.

FIG. 9 is a block diagram illustrating an example computing device for the system of FIG. 1, according to one embodiment.

### DETAILED DESCRIPTION

Methods, computer program products, and systems for capturing rental history of a particular renter that is verifiable and reliable, and where the renter can create and leverage their rental history with cryptographic tokens for gated access. One of ordinary skill in the art will recognize many alternative embodiments that are not explicitly listed based on the following disclosure.

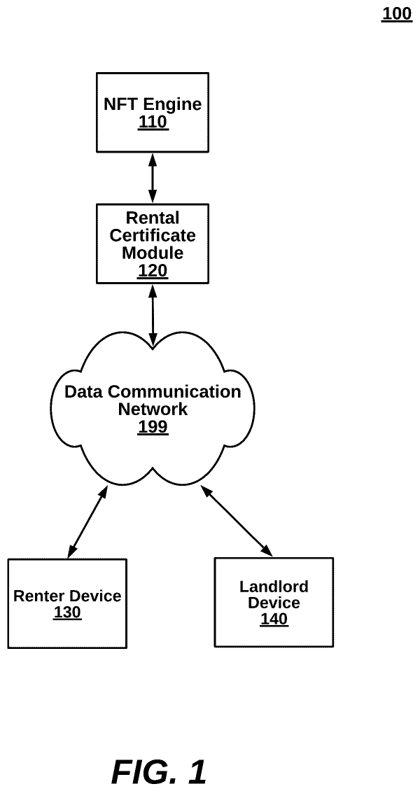

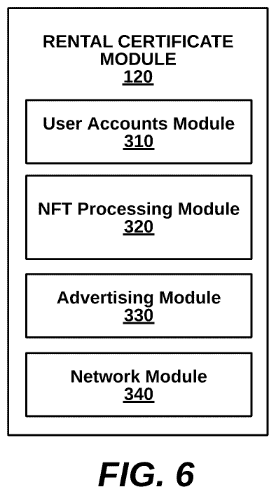

### I. Systems for NFT-Based Rental Certificates (FIGS. 1-6)

FIG. 1 is a high-level block diagram illustrating a system 100 for capturing rental history of a particular renter that is verifiable and reliable, and where the renter can create and leverage their rental history with cryptographic tokens for gated access, according to one embodiment. The system 100 includes an NFT engine 110, a rental certificate module 120 interacting over a data communication network 199 with a renter device 130 and a landlord (or other third party) device 140, as users of the system 100. In one embodiment, the NFT engine 110 and the rental certificate module 120 are integrated into a single physical device, and in another embodiment, communicate across the data communication network 199. Many other variations are possible.

The NFT engine 110 mints and allocates tokens providing access to token-gated content in response to a user satisfying specified token criteria. The NFT engine takes the complexity of the blockchain environment and abstracts it into a set of APIs and SDKs that can manage the entire process easily. For example, crypto wallets are front end technologies that require user interaction and input to mint an NFT from a smart contract. The NFT engine 110 is configured to be back end technology) by managing the complexity away from the user and providing for interaction via APIs. As such any front-end application can now interact with the blockchain without burdening the users with the intricacies of storing or managing their private keys and authorizing transactions to sign transactions to interact with the blockchains and mint, redeem, or create NFTs etc. The back end of the NFT engine is capable of supporting multiple applications simultaneously and while each application may be deployed by a unique customer. The NFT engine 110 maps the backend databases, digital assets, and the blockchain layer interaction to provide a simple workflow for businesses and enterprises.

Fungible cryptographic tokens are known. For example, one type of fungible token format is the well-known ERC-20 token. Non-fungible cryptographic tokens (NFTs) are known. For example, one type of NFT format is an ERC-721 token. Both are operable with an Ethereum virtual machine (EVM). While the token formats are known, each token can be configured to create unique functionality, unique expressions, or other unique aspects of the token. An NFT is a cryptographic token that represents ownership or other rights of a designated asset, e.g., a digital file or other assets associated with the token. Typically, the digital file or other asset is referenced in metadata in the token definition.

Token creation (e.g., minting) and transactions are typically handled via “smart contracts” and a blockchain (e.g., the Ethereum blockchain) or other distributed ledger technology. NFTs are minted according to known token minting protocols, but each can be configured with their own parameters to create uniqueness between the tokens. With some tokens, the token may be minted on demand when the token creator decides to mint the token. Some fungible tokens are minted and initially allocated via an initial coin offering. Some tokens are “pre-mined” and subsequently allocated. For example, once minted, an NFT can be offered for sale or acquisition via an NFT marketplace or other token sale or distribution platform.

The existing token minting and sale process suffers from various technical drawbacks and limitations. For example, conventional “smart contracts” have numerous advantages but are limited in that typically they can operate only on the data contained inside the nodes of the blockchain on which they run. This makes them like a self-contained system, closed to external sources. This can be problematic when external data is needed to satisfy conditions of the smart contract.

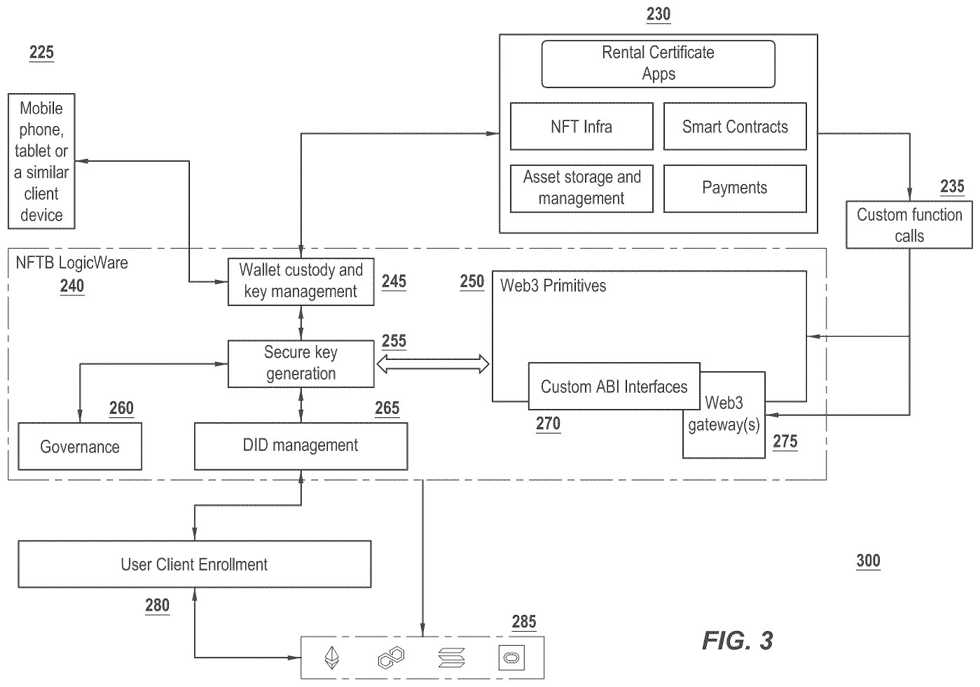

FIG. 3 illustrates one embodiment of a high-level architecture 200 and incorporating the NFT engine 110 with components 211A-G. Various other components and modules can be added to the NFT engine to accommodate customized NFT requirements.

System 200 offers a variety of features for supporting various applications 201A-D including location information or user ID that is accessible from a mobile or other device. The NFT engine application can be triggered by scanning a QR code, accessing a specific URL, or being sent to the user as an SMS or message.

The NFT Engine 110 interfaces with a variety of other software modules including the user experience modules 202 and the core software infrastructure modules 205, 210 and 220. In one embodiment, 201A is a location based application that is built leveraging the NFT engine 110. Applications could also be a non-location based application or any other generic application, such as one that allows users to access their rental history on a smart display system that provides blockchain and NFT functionality to the users.

Rental certificate apps 201B is another application or module that is responsible for showing and managing rental certificates and rental relationships between the tenant and the corner. Other applications from a user experience perspective may be streaming media or digital avatar applications such as streaming media apps 201C or AirDrops and Claims applications 201D, where users may claim an offer provided by an rental ecosystem partner via an NFT or a digital asset, such as AirDrops and Claims apps 201D. There may be many more applications that can be built on top of the NFT engine. These applications interface directly with the NFT engine via the front end UX and user wallet management modules 202. In addition these applications also interface with an administrative system or a backend, 220, which may be specific or customized for each application. The front end UX and user wallet management module 220 is connected to the LogicWare middleware platform 205 which in turn connects to blockchain and node management modules 210. It may be noted that all the components of the NFT engine may also be directly interconnected with each other to ensure proper data flow, data and identity management and access controls for the users. The administrative system or backend 220 connects to various blockchains including but not limited to Ethereum 215A, Polygon 215B, Avalanche 215C, Optimism 215D, Solana 215E, Ripple 215F, or any other EVM or non-EVM blockchain via custom RPCs and APIs. In addition the back end 220 provides support for asset and metadata storage 221A, authentication 221B, centralized storage 221C, or decentralized storage 221D.

Other modules and components of the NFT engine 110 include:
1. Smart contract deployment and management module 211A, that supports any underlying blockchain;
2. TokenID, nonce, airdrop claim management modules 211B to ensure individual transactions can be processed out of sequence as well in case certain transactions are held up in the execution queue'
3. Deployment wallets and scripts, wallet management including private key management and gas management 211C, with a variety of ways for managing private keys including encryption, utilizing key vaults, multi party computation techniques (MPC) or multi-signature wallet management'
4. Payments modules for both fiat as well as cryptocurrencies (211D) via payment gateways, integrating recording the transaction results and status directly into the blockchain;
5. CustomerID and Nonce management for individual customers (211E), similar to the user side described above, to ensure that transactions by different customers do not queue up and can be processed independently;
6. Integrated web2 and web3 analytics (211F) to map transactional information of users to their wallets. In addition, AI techniques and algorithms can be utilized to infer behavioral information about users independent of their demographic information; and
7. Integrated web2 and web3 identity management (211G) that allows for access controls to be implemented based on the digital wallets, ownership of media or avatars, or any other digital goods or identity modules including SSO and SAML.

The NFT engine 110 mints and allocates cryptographic experiential tokens entitling the user to access an information stored in the blockchain. In another aspect, token-gated access is granted to a resource providing access to token-gated content in response to a user satisfying specified token criteria.

Web3 represents a shift towards a more decentralized, transparent, and user-centric internet, where individuals have greater control over their online interactions and data. Web3 refers to a next generation of the internet, where decentralized networks, blockchain technology, and cryptocurrencies are integrated to create a more open, secure, and user-centric internet. Unlike Web 2.0, which is characterized by centralized platforms and services controlled by large corporations, Web3 aims to decentralize the internet, giving users more control over their data and online interactions.

In Web3, users interact with decentralized applications (dApps) that run on blockchain networks, such as Ethereum, and communicate through peer-to-peer protocols. This enables trustless transactions, where intermediaries are eliminated, and transparency is ensured through the immutability of blockchain technology.

One of the key features of Web3 is the use of smart contracts, which are self-executing contracts with the terms of the agreement directly written into code. Smart contracts enable automated and tamper-proof agreements, facilitating various applications such as decentralized finance (DeFi), non-fungible tokens (NFTs), decentralized exchanges (DEXs), etc.

Immutable refers to the inability to modify or tamper with data once it has been recorded. Transactions and data recorded on a blockchain are immutable, which means that they cannot be altered or deleted retroactively. This immutability is achieved through cryptographic hashing and the decentralized consensus mechanisms employed by blockchain networks. The immutable nature of blockchains ensures data integrity, transparency, and an auditable trail of all activities, which is crucial for applications requiring tamper-resistant record-keeping and trustless interactions. Data can also be stored immutably over the InterPlanetary File System (IPFS), which uses content-addressing to store immutable data in a distributed file system. This complements the immutable data storage capabilities of blockchains. Data can be stored on IPFS instead of directly on a blockchain due to the significant storage constraints and costs associated with recording large amounts of data on most blockchain networks. By storing the data immutably on IPFS and recording just the content-addressed IPFS hash on the blockchain, applications can leverage the immutability and tamper-resistance of both systems while optimizing for efficient data storage.

Ingesting data is the process of importing assorted data files from one or more sources into a cloud-based or on-premise storage medium, a data warehouse, data mart, InterPlanetary File System (IPFS), decentralized storage network, or any other structured or unstructured database where it can be accessed and analyzed. This process involves extracting data from various sources, transforming it into a compatible format, and loading it into the designated storage or a processing system. Efficient data ingestion mechanisms are crucial for handling large volumes of data from multiple sources in real-time or batch modes. The ingested data can encompass various formats, including text, numerical data, audio, video, and multimedia content. The ingested data can originate from databases, log files, IoT devices, social media platforms, or any other data-generating source, enabling organizations to consolidate and derive insights from diverse data sets. Robust data ingestion pipelines ensure data integrity, scalability, and integration with downstream analytics and processing systems.

A backpack is a cryptographic construct that binds a user's digital identity, data, credentials, or any other digital assets to a non-fungible token (NFT) or other blockchain-based token. This account backpack NFT serves as a secure, portable representation of the user's identity, data, credentials, and other assets across different applications. By leveraging the immutability and trustless characteristics of blockchain technology, the account backpack provides users with self-sovereign control and management of their digital identity and assets within a unified repository while maintaining security, transparency, and an auditable record of account activity.

Binding refers to the cryptographic process of associating a user's digital identity, credentials, assets, or data with a specific blockchain token or non-fungible token (NFT). This binding establishes an inseparable link between the token and the account, ensuring that the account's contents are inextricably tied to the token's ownership and transfer. The binding mechanism leverages cryptographic primitives like digital signatures and hashing to create a secure and verifiable connection between the account data and the fungible or non-fungible tokens. Once bound, the account and its associated data can only be accessed, modified, or transferred by the rightful owner of the corresponding token, as established by the private key/wallet address pair, providing self-sovereign control over the digital assets, identity and credentials.

A series of NFTs may refer to a chronological sequence of recorded activities, actions, or occurrences. Each NFT that is created in the series may be appended as an immutable entry, preserving the order and integrity of the overall series. The series of NFTs therefore allows for a transparent and auditable log of all events that have transpired within a system or process. As such, the system ensures a verifiable history that cannot be retroactively modified, enabling trustworthy record-keeping and traceability of operational activities over time.

An interval represents a specific, finite period or window of time that is consumed or utilized in its entirety. An interval has a defined start and end point. Once an interval has been allocated or assigned for a particular purpose, it cannot be reused or reassigned until it has been fully consumed or expired. This property of intervals ensures exclusivity and prevents overlapping usage conflicts within the designated time window. For example, if data from a particular interval has been converted to an NFT for audit purposes, the same data may not be included in another interval for a second NFT, as it may lead to double counting of the resources utilized in the interval. Such double counting can lead to conflicts and destroy the integrity of the data.

As depicted in FIG. 3 an application or dApp may consist of several components including smart contracts deployed via the module 211A or otherwise imported into the application, NFT infrastructure modules such as 211A, 211B, 211C, 211D, 211E, 211F, 211G, asset storage and management 221A, 221C, 221D, or payments 211D.

The system 200 may employ computer code modules (e.g., smart contracts) configured to manage the assignment of the non-fungible cryptographic tokens to designated digital wallet addresses associated with corresponding owners of the non-fungible cryptographic tokens. Digital wallets, or e-wallets or cryptocurrency wallets, can be in the form of physical devices such as smart phones or other electronic devices executing an application or electronic services, online services, or software platforms. Devices serving as digital wallets may include location-based services capabilities, e.g., GPS, UWB, BLE and other capabilities. Digital wallets may provide a store of value or a credit or access to credit and may be in the form of a digital currency or involve a conversion to digital currency, tradeable digital asset, or other medium of exchange. The stored value accessible using a digital wallet may involve authentication to access ownership records or other indica stored in a digital ledger or DLT and requiring authentication and/or other decryption techniques to access the store of value. Parties may use digital wallets in conducting electronic financial transactions including exchanges of digital currency for goods and/or services or other considerations or items of value. Transactions may involve use of merchant or other terminal equipment and involve near field communication (NFC) features or other communication techniques and use a computer network. In addition, digital wallets may include identifying or authenticating information such as account credentials, loyalty card/account data, and driver's license information, and the transaction may involve communicating information contained or stored in the digital wallet necessary to complete intended transactions.

The NFT engine application allows users to log in with their email, any social network, or single sign-on service such as Okta. Users can associate their login details with a wallet address on a blockchain (a public key typically) and store a corresponding private key. The private key is a highly confidential key that authorizes transactions on the blockchain, proving ownership of the associated digital assets. The wallet address is the public counterpart, similar to a public address, that serves as a store of digital assets. Users can claim a digital asset by presenting the public key to the application configured with a smart contract, make payments by fiat or crypto, redeem a code, whitelist wallet addresses to mint an asset, and blacklist wallet addresses to block them from interacting with the application.

The application is governed by smart contracts, specifically an EVM compatible smart contract. Smart contract deployment and management module 211A allows for unique digital assets (ERC 721), copies of unique digital assets (ERC 1155), mix and match of various other digital assets (ERC998), and semi-fungible tokens (ERC3525). It also allows for the rental of digital assets, and assets created via the smart contract can be imported within a metaverse environment.

A smart contract is deployed by creating a private key/wallet address pair separate from any other wallet, known as deployment wallets represented in module 211C. These wallets do not hold any digital assets (or NFTs) but may hold cryptocurrencies. The deployment wallet may pay for transactions related to the digital assets created via the smart contract, and transactions may be paid by an eventual buyer of the digital assets. The smart contract can be automatically configured and deployed via API calls, on-demand or in real-time, and on a choice of blockchains or test network environments. Payments (fiat and crypto) are handled by module 211D.

Digital assets are stored, and they may or may not be transferable to any other wallet address on the blockchain. Payments are processed by module 211D by storing the confirmation ID and token ID as proof of payment on the blockchain when the token is minted.

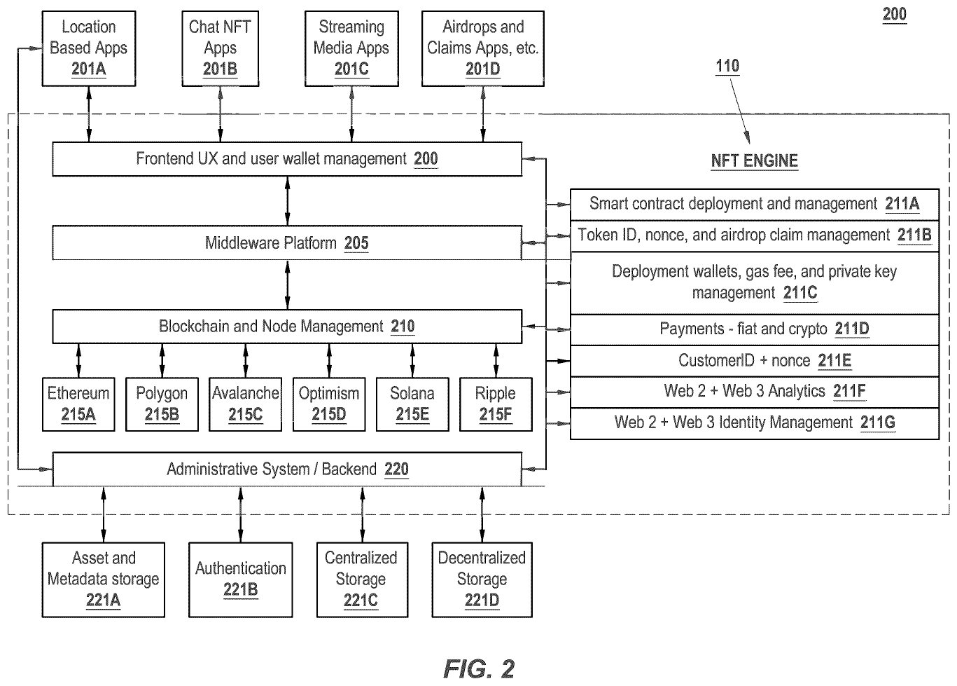

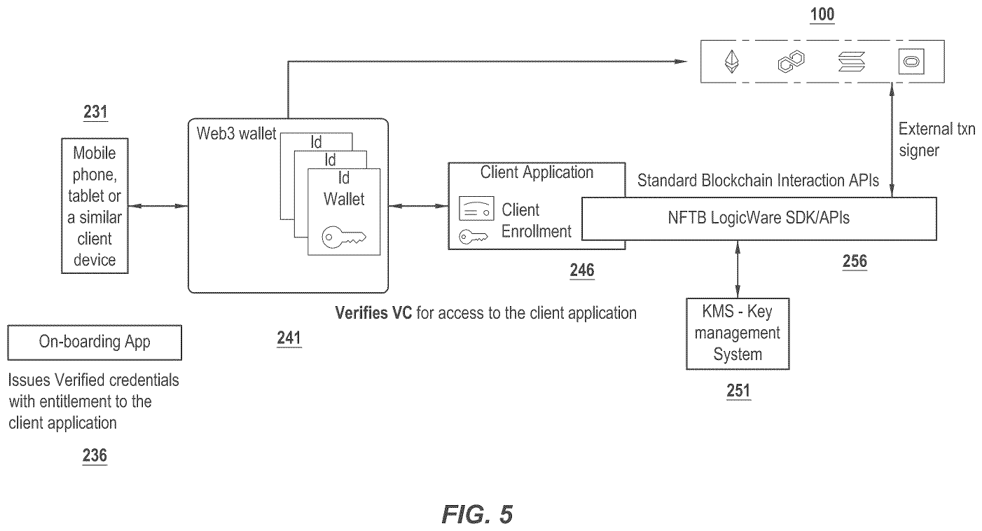

FIG. 5 illustrates an exemplary high level architectural view 300 of an NFT-based rental certificate system wherein the capabilities and features of NFT engine 110 of FIG. 2 is incorporated into LogicWare 240 where the engine is represented as Web3 Primitives 250. Various other components and modules can be added to this architecture to accommodate customized NFT requirements.

The end user may log in into the platform using a mobile phone tablet or similar client device 225. The application running on the device interacts with the NFT middleware platform via the NFT LogicWare 240. Similar in capability to middleware platform 205, LogicWare 240 determines the wallet custody and key management protocol 245 that applies to the particular rental certificate application 230 and its user and logs the user in into the application. If the user interacts with the application or dApp the first time, the custody and key management protocol 245 generates a new key pair using the secure key generation module 255 for the user and associates it with the user's digital identity. Optionally secure key generation 255 may also associate the keys with a decentralized identity and issue verified credentials to the user. Additionally, LogicWare also creates or associates the governance policies 260 that the user identity may be subject to. If the user is a returning user, the LogicWare retrieves the keys and based on the governance and access control rights, allows the user to access the application or the dApp. As depicted in FIG. 2 the application or dApp may consist of several components including smart contracts deployed via the module 211A or otherwise imported into the application, NFT infrastructure modules such as 211A, 211B, 211C, 211D, 211E, 211F, 211G, etc., asset storage and management 221A, 221C, 221D, or payments 211D.

The application interfaces with the NFT middleware (LogicWare) 240 via custom function calls APIs and SDK's 235. The LogicWare 240 for NFTs includes various Web3 primitives, 250, that are interoperable building blocks that are highly reliable in executing transactions over a blockchain providing similar features and capabilities described in system 200 including communicate with backend and frontend systems, work with storage components (e.g., 221C, 221D), utilize analytics from modules, similar to web2 and web3 analytics (211F), identify users using an identity management module, secure the applications using authentication, identity management, or implement access controls with 211G, 211B, etc. or provide for a governance layer in combination with the governance module 260. Web3 primitives 250 also communicate with custom ABI interfaces, 270, and web3 gateways 275 for deploying smart contracts to their respective blockchains, interacting with smart contracts, and executing the functions and instructions in the smart contracts.

The LogicWare optionally comprises a governance (260) and a Decentralized Identity (DID) management module (265). DIDs are an important part of securing identity and making it interoperable across both web2 and web3 platforms.

Applications in web3 are also referred to as dApps. Governance in decentralized applications (dApps) in and communities refers to the processes and mechanisms through which decisions are made and actions are taken within the decentralized ecosystem. In traditional centralized systems, governance is typically controlled by a central authority, whereas in decentralized systems, governance is distributed among network participants. In one embodiment, the decision making and governance is in part based on the decentralized identity of the users themselves, who interact with the dApp and the associated smart contracts with their wallets and their corresponding private keys. The Governance module 260 within the LogicWare allows for implementing various governance mechanisms and resource allocations. In conjunction with the DID management module 265, the governance module 260 also employs mechanisms to prevent Sybil attacks or other malicious attacks on the system, such as, where an individual may create multiple identities to gain disproportionate influence for voting purposes. Sybil resistance mechanisms can include reputation systems, stake-weighted voting, or identity verification to ensure that governance decisions are made by genuine participants.

The DID management module 265 handles web2 and web3 identity management. The module utilizes methods for decentralized technologies, such as distributed ledgers (e.g., blockchain) or peer-to-peer networks, to enable the creation, management, and verification of DIDs and associated digital identities. As such, the DID created for any user can be used as an identity across any blockchain and helps identify the user on the application, without compromising the user's actual identity or demographic information. The users retain full control over their DID and can choose to lock and selectively share their information using their DIDs. In particular, this is an efficient way of combining various private blockchain systems favored by enterprises, with the public blockchain systems. With a DID, a user can retain the same wallet address to make transactions over any supported blockchain.

Various blockchains may have different ways to monitor and govern the identity of the users. In order to map the identity from one system to another, it may be necessary to homogenize the identity across the multiple platforms by implementing a client enrollment module 280 to create a system where the identities from one system may map directly to an identity on another system, without the need for any user intervention. For example, when making a private blockchain system to be compatible with a public blockchain such as Ethereum, Polygon or Solana, it may be essential to create a user (client) enrolment into the Hyperledger based system and map it to the private keys for the eventual user of the system.

### A. Artificial Intelligence for Gathering and Analyzing Renter Data

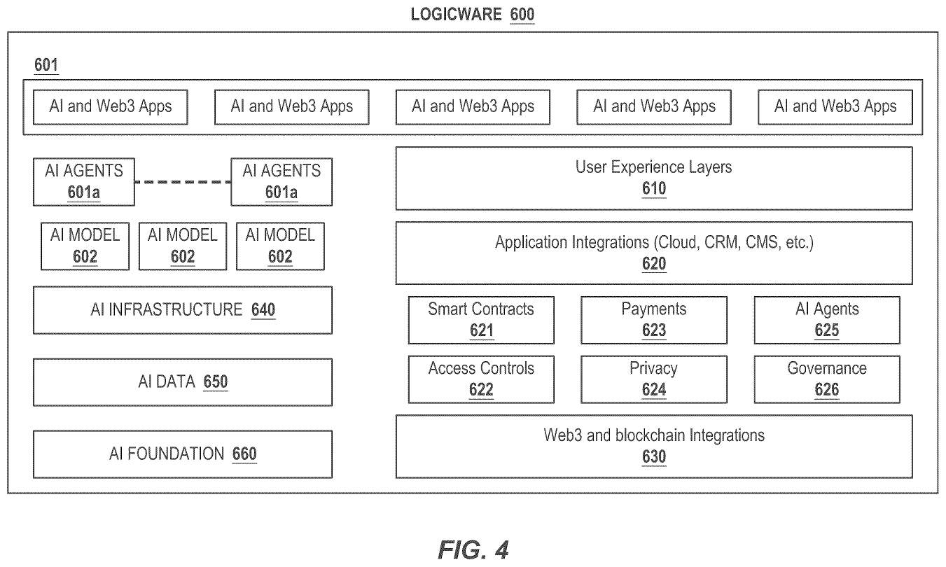

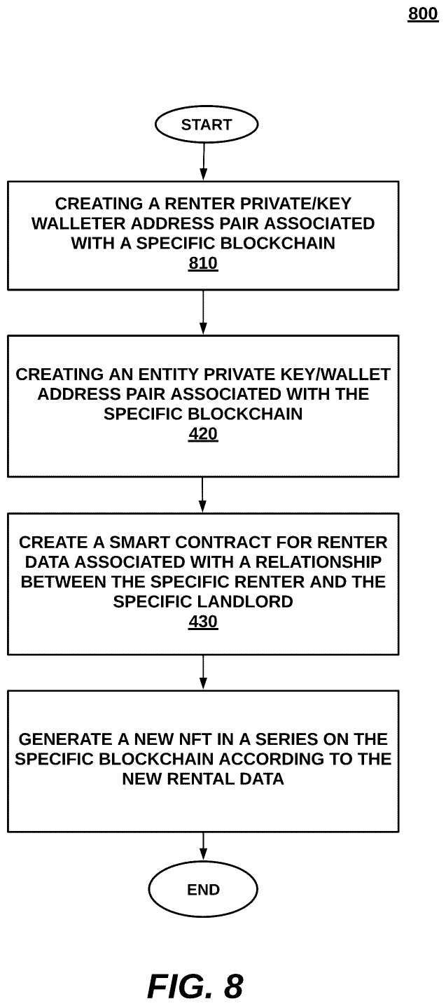

FIG. 4 is a block diagram illustrating the elements of the LogicWare with blockchain and Web3 interfaces, according to an embodiment. The Logicware system 600 depicted in FIG. 8 abstracts away many of the complexities involved in building and operationalizing AI systems, enabling developers and applications to focus on leveraging AI capabilities rather than dealing with low-level infrastructure concerns. AI Foundation 660 refers to the underlying platform enabling the integration and deployment of artificial intelligence capabilities within LogicWare 600 as depicted in FIG. 8. The AI Foundation 660 serves as a common layer that provides essential services and components required for developing, deploying, and managing AI models and applications. AI Foundation may be part of the LogicWare 600 deployed as SDKs or made available to Logicware via APIs. AI Foundation may include or support the following key elements:
Data ingestion and preprocessing: Components for collecting, cleaning, and preprocessing data from various sources to prepare it for use in AI models.
Model development and training: Tools and environments for building, training, and evaluating AI models 602, such as machine learning, deep learning, or natural language processing models.
Model management: Services for versioning, storing, and managing trained AI models 602, as well as monitoring their performance and updating them as needed.
Inference and deployment: Mechanisms for deploying trained AI models into production environments, allowing applications and systems to consume and leverage the AI capabilities.
Scalability and performance: Infrastructure 640 and services that enable the efficient scaling and high-performance execution of AI workloads, often involving specialized hardware like GPUs or TPUs and cloud-based services.
Security and governance: Mechanisms for ensuring the secure and compliant use of AI models, including access control, auditing, and adherence to regulatory requirements.
Integration and APIs: Interfaces with Application Integrations 630 and APIs that allow other applications and systems to seamlessly integrate and consume the AI capabilities provided by the foundation such as process systems 621-626.

AI Foundation 660 aims to provide a standardized and consistent platform for AI development and deployment for Logicware across the organization, promoting reusability, scalability, and governance of AI solutions. Some of the features of the AI Foundation 660, may also integrate with cloud, CRM, CMS and other systems.

AI Data 650 refers to the information used to train and develop artificial intelligence systems. This data can be in various forms, such as text, images, audio, or numerical data, depending on the application of the AI system. Ensuring the quality, relevance, and diversity of AI data is crucial for building accurate and unbiased AI models. AI data can be both structured and unstructured:
1) Structured data refers to information that is organized and formatted in a predefined way, such as databases, spreadsheets, or labeled datasets. This type of data is typically used for tasks like classification, regression, or structured prediction problems.
2) Unstructured data, on the other hand, refers to information that does not have a predefined format or structure, such as text documents, images, audio files, or social media posts. This type of data requires more preprocessing and feature extraction techniques before it can be used for training AI models.
3) Many AI applications, especially in areas like natural language processing (NLP) and computer vision, rely heavily on unstructured data, while structured data is more commonly used in fields like finance, healthcare, and manufacturing.

Logicware works with both structured and unstructured data which can also be integrated via application integrations 620.

AI infrastructure 640 refers to the combination of hardware and software resources required to develop, train, and deploy artificial intelligence systems effectively. It includes powerful computing resources, such as GPUs, TPUs, or specialized AI accelerators, to handle the computationally intensive tasks involved in training large AI models. AI infrastructure also encompasses the software platforms, frameworks, and tools used for data preprocessing, model building, training, and inferencing, which may also be a part of the AI Foundation. Additionally, AI Infrastructure 640 may involve storage and data management solutions to handle the vast amounts of data required for AI model training. The system in FIG. 8 enables robust AI infrastructure is crucial for organizations to scale their AI initiatives and achieve efficient model development and deployment cycles. An NFT engine is incorporated into the LogicWare system 600 as elements 610-630.

AI models are mathematical representations or algorithms that are trained on data to learn patterns, make predictions, or take actions. They are the core components of artificial intelligence systems that enable them to perform specific tasks, such as image recognition, natural language processing, or decision-making. AI models can be deep learning models, like convolutional neural networks or transformers, or more traditional machine learning models like decision trees or support vector machines. The performance and accuracy of an AI model depend on the quality and quantity of the training data, the model architecture, and the techniques used for training and optimization.

AI agents are software programs that employ artificial intelligence techniques to operate autonomously or semi-autonomously in a variety of environments, making decisions based on input data, predefined rules, machine learning models, or a combination of these methodologies. Typically, AI agents are capable of performing tasks independently without human intervention, adjusting their actions based on the analysis of incoming data. In this way they are an extension of an analytics engine and make it easy to take actions based on the underlying analysis for the data that they operate upon, such as rental information data. These agents can improve their performance over time through learning mechanisms, based on the data itself. They adapt by observing outcomes and integrating new knowledge into their decision-making processes, retraining their algorithms in light of the new data. AI agents continuously perceive their environment and can react to changes in real-time or near real-time. Beyond reactive behaviors, AI agents can also exhibit goal-oriented behaviors, initiating actions based on predictive analytics and strategic planning. The design allows these agents to handle increasing amounts of work or to be easily expanded to manage complex or additional tasks. The output of AI agents can be information that can be represented as metadata and associated with an NFT. In one embodiment AI agents can be used to process data and create metadata that can be immutably recorded and attached to an NFT.

These AI agents can be implemented using a variety of technical frameworks and methodologies, including but not limited to:
Machine Learning and Deep Learning: Utilizing algorithms and neural networks to analyze data, recognize patterns, and make decisions.
Natural Language Processing (NLP): Enabling the understanding and generation of human language, facilitating interactions between humans and machines.
Robotics: Applying AI in mechanical or virtual robots, connected devices, IoT (Internet of Things) devices, etc. allowing for physical interaction with environments.
Expert Systems: Incorporating rule-based systems that mimic the decision-making abilities of a human expert.
Data Analysis Systems: Designed to interpret vast datasets efficiently and accurately to derive meaningful insights.

AI applications can be utilized in a wide range of fields, including computer vision for object detection and recognition, natural language processing for text analysis and generation, predictive analytics for forecasting and decision support systems, as well as robotics and automation for task planning and control. The proposed invention leverages novel AI models and algorithms to achieve improved performance, efficiency, or functionality compared to existing approaches. These applications can find use in a variety of different industries and for numerous use cases such as healthcare diagnostics, financial fraud detection, recommendation systems, language processing, customer service, etc. The AI application can be implemented on various hardware platforms, such as cloud computing infrastructure, edge devices, or specialized AI accelerators, enabling scalable and cost-effective deployment.

Various cloud vendors provide platforms and services that support the development and deployment of AI agents. These cloud vendors are continuously adding support features, improved capability and services in support of their cloud offerings. Some of the major providers include Amazon Web Services (AWS) (Amazon Lex: A service for building conversational interfaces into any application using voice and text; Amazon Polly: A service that turns text into lifelike speech, allowing users to create applications that talk; Amazon Rekognition: A service for adding image and video analysis to applications; Amazon Comprehend: A natural language processing (NLP) service for understanding the content of text documents; Amazon SageMaker: A fully managed service that provides developers and data scientists with the ability to build, train, and deploy machine learning (ML) models); Microsoft Azure (Azure Bot Service: A service that enables you to build intelligent, enterprise-grade bots that help enrich the customer experience while reducing costs; Azure Cognitive Services: A set of APIs, SDKs, and services available to help developers build intelligent applications without having direct AI or data science skills; Azure Machine Learning: A cloud-based environment that a user can use to train, deploy, automate, and manage machine learning models0; Google Cloud Platform (GCP) (Google Dialogflow: A natural language understanding platform that makes it easy to design and integrate a conversational user interface into mobile app, web application, device, bot, interactive voice response system, and more; Google Cloud Speech-to-Text and Text-to-Speech: APIs for converting audio to text and vice versa; Google Cloud Vision API: Enables developers to understand the content of an image by encapsulating powerful machine learning models in an easy-to-use REST API; and Cloud Natural Language API: Provides natural language understanding technologies to developers).

These cloud vendors offer a wide range of AI and machine learning tools and services, enabling developers to create sophisticated AI agents, chatbots and virtual assistants.

FIG. 5 illustrates the use of verified credentials (VCs) for authentication into the ecosystem of applications 400 for access control or user onboarding features.

When a user logs in to the platform using a mobile phone, tablet, desktop, or a similar device, 231, the onboarding application, 236, or dApp issues a verified credential (VC), to the user. It may be noted that the VC may be issued by a third party application separately and imported into the client application. These VCs allow the user to access other connected applications or dApps that the user may wish to, such as loyalty programs, using their decentralized identity. As such verified credentials (VCs) act as an authentication mechanism for users to use the appropriate wallets as a proxy for their identity on the system. A user may have multiple wallets associated with their identity. When a user logs in to the application or dApp, the LogicWare 256 for this embodiment identifies the appropriate identity to use and retrieves the appropriate keys from the key management system, 251. This in turn allows the application or dApp, 246, to transact with the blockchain using the appropriate identity and the private keys associated with them. A user's public key may be stored on the blockchain which allows anyone to verify the authenticity of messages, transactions, or other data associated with that identity.

FIG. 5 is a detailed block diagram 500 illustrating a rental certificate module 120 of the system of FIG. 1, according to an embodiment.

The rental certificate module 120 is detailed in FIG. 5, and includes a user accounts module 310 for renters, landlords, credit bureaus, and advertisers to interact with a front end of the system 100 with a user interface. An NFT processing module 320 interoperates with the NFT engine 110 as a back end using APIs and other communication techniques, per user instructions. Additionally, AI agents can be used to facilitate automated data reporting service processes that may interact with the NFT processing module 320 automatically.

Automated data reporting service processes such as AI agents Artificial intelligence agents (or AI agents) are software programs or algorithms designed to perform specific tasks autonomously, making decisions and taking actions based on predefined rules, learning from data, or adapting through machine learning techniques. AI agents can leverage data, including data associated with NFTs, to perform various tasks and processes. AI agents are used in various applications across different domains, including:
Virtual Assistants: AI agents like Siri, Alexa, and Google Assistant interact with users, understand natural language, and perform tasks such as answering questions, setting reminders, and controlling smart home devices.
Chatbots: AI agents used in customer service and support systems to interact with users, answer questions, provide assistance, and handle simple tasks.
Recommendation Systems: AI agents analyze user behavior and preferences to provide personalized recommendations for products, movies, music, and content.

AI agents can be simple or complex, depending on the task they are designed to perform. They can also range from rule-based systems to advanced machine learning models capable of learning from data and improving their performance over time

AI agents can perform a wide range of tasks across various domains, including:
Natural Language Processing (NLP): AI agents can translate text or speech from one language to another (Language Translation), analyze text data to determine the sentiment expressed (Sentiment Analysis), and identify and classify entities mentioned in text data, such as names of people, organizations, or locations (Named Entity Recognition (NER));
Computer Vision and Object Detection: AI agents can identify and locate objects within images or videos;
Image Classification: AI agents can classify images into predefined categories;
Facial Recognition: AI agents can recognize and identify human faces in images or videos;
Data Analysis and Predictive Modeling: AI agents can analyze historical data to make predictions about future events or trends (Predictive Analytics), identify unusual patterns or outliers in data (Anomaly Detection) and forecast future values based on historical time series data (Time Series Forecasting);
Healthcare: AI agents can assist healthcare professionals in diagnosing diseases and medical conditions based on patient data. and can analyze patient data to recommend personalized treatment plans;
Finance: AI agents can analyze financial data and facilitate transactions, identify fraudulent activities by analyzing financial transactions and assess the creditworthiness of individuals or businesses based on their financial history;
Virtual Reality (VR) and Augmented Reality (AR): AI agents can enhance user experiences in VR and AR applications by providing intelligent interactions and personalized content;
Cybersecurity: Intrusion Detection: AI agents can detect and respond to security threats in computer networks;
Malware Detection: AI agents can identify and neutralize malicious software; and
Content Creation: AI agents can generate text, images, music, and other forms of content automatically.

AI agents can be linked to NFTs in several ways:
Ownership and Authentication: NFTs can be used to prove ownership and authenticate AI agents. Each AI agent can be represented by a unique NFT, and ownership of the agent can be transferred via the NFT;
Training Data and Model: NFTs and their associated metadata can represent the training data used to train the AI agent or the model itself. This can ensure the transparency of the AI's capabilities and its training data;
Royalties and Intellectual Property Rights: NFTs can also be used to manage royalties and intellectual property rights associated with AI agents. Creators can receive royalties whenever their AI agents are used;
Marketplaces and Trading: NFT marketplaces can facilitate the trading of AI agents. Creators can sell, buy, or exchange AI agents using NFTs, with the ownership of the AI agent being transferred along with the NFT;
Customization and Upgrades: NFTs can represent unique features, attributes, or upgrades of AI agents. For example, owners can share or grant temporary access to NFTs to advertisers or landlords to represent these features and allow them to apply AI agents to customizing or personalizing communication according to preferences; and
Provenance and History: NFTs can store the provenance and history of an AI agent, including its previous owners, usage history, and any modifications made to it.

By linking AI agents to NFTs, creators can ensure ownership, authenticity, and traceability, while also providing a platform for trading, sharing, accessing, customizing, and monetizing data accessible by AI agents.

Automated data reporting service processes may include:
1. Database services designed to manage, query, and report data from relational, non-relational, or vectorized databases efficiently.
2. Business intelligence tools that collect and process large amounts of unstructured data from internal and external systems, prepare it for analysis, develop queries against that data, and create reports, dashboards, and data visualizations.
3. Data Warehousing Solutions that aggregate data from multiple sources, making it easier to provide comprehensive reporting and analysis. They often include tools for automated reporting and data analysis.
4. AI powered analytics platforms that use artificial intelligence to analyze data and generate reports. They can identify patterns, trends, and anomalies without human intervention.
5. AI agents that meet specific business needs, capable of extracting data from various sources, analyzing it using machine learning models, and generating tailored reports. These agents can be trained to provide insights specific to the business's operational, tactical, or strategic queries. For example, AI agents can read metadata for identifying the traits of renters, and AI agents can sift through the rental data to create the metadata for NFTs and mint those NFTs

These automated data processing reporting services may also include spreadsheet tools with automation features, API based tools, cloud based reporting services, ETL (extract, transform, load) tools or any combination of the above.

An advertising module 330 in FIG. 5 is a portal that identifies advertising opportunities for advertisers, as described further below. A network module 340 connects to communication channels, such as Ethernet, Wi-Fi or the like, to exchange data.

The rental certificate module 120 captures information during the time of the relationship or rental relationship between a renter and landlord, preferably as digital certificate or NFT stored in a database or blockchain that captures/tracks rental payments. A renter who pays on time would expect the landlord to verify that they paid their rent on time. That verification would be tracked digitally and stored perhaps in a digital domain such as a blockchain or cloud service that captures the verified timely payment. The renter can see that the landlord verified the timely payment either by getting a record of the confirmation or checking on the blockchain to verify that the landlord had confirmed the payment. If the renter does not get the confirmation they can tell the landlord to verify the payment. This is easier done because the renter and landlord have a then-current relationship. If the renter does not get the cooperation of the landlord then the landlord risks getting a bad reputation so that subsequent renters may be reluctant to rent from that landlord because they also know that if they paid on time their timely payment would not be adequately captured.

An evaluation and rating tool of landlords can also be created or supported by renters. Just as a landlord would verify payment history and the like, NFT metadata could be designed to record or represent tenant assessments and complaints (i.e., how well did the landlord respond to premises issues or how well did the landlord respond to updating tenant payment history). In this way, landlords could build up their reputation as responsive owners to support higher rental rates, for example. So there is an incentive for all parties to cooperate on a platform that captures this information. Accordingly, the platform can be used by renters and landlords to incentivize and reward good behavior. Renters can use their timely rental payment information when they are moving into a new place, perhaps negotiating better future rent because they have a track record of doing timely payments. Landlords have an incentive to encourage good behavior, especially if there is a program where they can verify and validate timely payments by the renter. Plus the landlord can have a platform where they can access verifiable information for prospective tenants regarding rental and tenancy history.

This platform offers additional benefits as well. Advertisers would be interested in knowing when a new tenant moves into a new unit or property and can include the duration of tenancy. When a landlord and renter establish a new relationship, the platform can capture that information or record it in the blockchain or database in a way that can be leveraged for advertisers to know that there is a new rental arrangement. Currently, there's no reliable or complete solution that captures rental agreements or their duration in a way that can be conveniently accessed. New rental agreements that are entered into are usually only known by the renter in the landlord or the rental company. Advertisers would be interested in knowing when there is a new rental arrangement. This advertiser interest is because when the renter moves into a new place they need to furnish and buy new things. This is a time where a lot of purchases are typically needed. Also, as tenants move into new areas they would want to know where the new restaurants or grocery stores or service providers such as barbers, groomers, optometrists, dentists, medical facilities, schools, etc. By utilizing automated data reporting service processes, such as AI agents, for example, this platform becomes a positive way for advertisers to promote or offer their services and availability thereof and educate tenants as to what available services are nearby. New tenants would like this information because it's a great way to become accustomed to their new area. Landlords would like this because it's a great way for landlords to show how close amenities are or what amenities are nearby.

Automated data reporting service processes, such as AI agents and AI powered analytics allows renters to create a transparent, reliable process for tracking rental history and rental terms/lengths, beneficially allowing advertisers to target or track good users who are good tenants should the renter desire or have incentives be allowed or encouraged. If renters are good tenants that pay on time they are also very attractive to advertisers who are looking for reliable people to sell to. If people or renters move to new locations many brands or services would like to maintain that relationship. Or renters that pay on time would like to use that information or use their rental history as a way to benefit from potential new service providers. So, renters paying on time not only get an advantage with landlords, they also could use that rental history as a way to be incentivized or promote their payment history to new service providers or retailers. Individuals who pay their rent on time are reliable and are attractive to advertisers who want to generate relationships with them.

These relationships that are developed with advertisers would then be able to associate with the renters as renters move to new rental locations (and may be controlled or managed by the renters). Advertisers or service providers locally who generate relationships with renters would like to maintain those relationships as those renters move to new locations or as they move through their life. It is common for renters to move within a local area so that those relationships with local service providers are helpful to be maintained.

Also, as renters move to new locations perhaps they are evolving and their needs change. For example, if a renter is renting in college with roommate(s), those locations can be tracked or categorized as a college area. As they move from a studio or one-bedroom or two-bedroom unit to a three-bedroom house, the platform can recognize or anticipate that perhaps this renter is now raising a family (or the renter can choose to specify family status or number of people living at a location) or has a higher-paying job or is working in a particular location that has a higher income level in that area. Then as service providers and advertisers target those renters, the renters can be targeted with more relevant information that's tied to their lifestyle or where they are in life. Perhaps it's determined or it becomes likely that the renter has children, then education or children-focused information is more effective that reflects the lifestyle that those renters lead. The benefit here is that while a new rental agreement has been put in place, the system knows or can infer more about the renter situation that would not have been known previously through a run-of-the-mill rental application. In other words, the platform in tracking a user's rental history would be able to evolve and carry the information forward with the renter so that the renter or system can create and update a profile much easier. For example, service providers or retailers targeting families would like to have access to verifiable or verified reliable information about the renters and their situation in life and may be willing to incentivize or pay the renter for access to their digital certificate (or pay for an NFT minted by the renter). Using automated data reporting service processes such as AI agents, the platform can track users' interaction or their location so that localized services can be more catered to a renter and more relevant advertising can be targeted or provided to the renter. The NFTs themselves can be based on ERC721, 1155, 998 (composable NFTs), or 4907 (NFT rentals) or any other standards that may be developed or deployed. NFT standards could also be on any blockchain including but not limited to Ethereum, Polygon, Solana, Base etc.

In another embodiment, the digital certificate can be managed by the renter. The renter can create an NFT that is a digital certificate that they can control who has access to it. So if a renter develops a very reliable rental history they can choose to use it or share it with a prospective landlord or business. If they are open to obtaining targeted and relevant ads or discounts or services that are localized or relevant, they can sell or control tokens to entities representing their digital record or certificate. In this aspect the renter would control their information and who may have access to it. The renter could track who is accessing or can access their information or using that information so in a case where a prospective landlord wants to access a user's rental history, the renter can give the prospective landlord a token or rights to access the information on the digital certificate or NFT. If the information is stored on blockchain, the renter can give or share access to that information to a prospective landlord in a transparent fashion. If the information is stored on a private blockchain, the renter can provide token access to a prospective inquirer who would want to access that information. If the information is stored on a public blockchain, the renter could track who is accessing that information. What this platform does is give more control to the renter in terms of who can access the information, and the renter gets to control whether or not they want to share that information or gets to control and get compensated for sharing up information because advertisers or landlords may be more willing to pay for that information (that is permissioned by the renter and difficult to obtain and gather elsewhere) since its verifiable and it's controlled by the user. In this way, the renter can choose to sell tokens or access rights to information and benefit financially from their rental or credit history. To further benefit the renter, the landlord, and any third parties, automated data reporting service processes such as AI agents can create necessary reports, analytics, and actions that may provide business, marketing or any other benefit.

The rental history platform uses token-based technologies to grant access to information that is preferably stored on the blockchain as a digital certificate or information or NFT (non fungible token) that the renter has visibility into as to who can access that information or who is accessing that information. The ability of the user to control who accesses the information for example, in a private blockchain, gives the incentive to a user to create a strong rental history profile that is not captured in traditional credit reports. And the user can control that information and generate a history of how well they've paid or taken care of the rental property. Renter payment history and where they lived and where they move to and whether or not they had roommates, all this information can go into the digital certificate or the blockchain in a way that allows analysis to create a scoring mechanism controllable or shareable by a user for obtaining benefits.

The platform can also be used by apartments or landlords to learn more about the requirements and priorities of the renters. This can be accomplished by the automated data reporting service processes such as AI agents. Traditionally, landlords maintain their own websites that list available properties or they go through a third-party websites such as Zillow or Craigslist to list properties. In this approach, the only information that is really shared is the availability of the property with relevant fixed information such as the number of bedrooms, square footage rental amount and location in the light. However, these systems are not tailored to a particular renter. The information displayed is the same to everybody so that if a renter was anticipated to be more interested in the school system or particular amenities, they would have to hope that the landlord in their universal advertisement provided that information, or the renter would have to dig through the listing and research further to learn about particular interest or information relevant to that renter. Or, the renter would need to go through some sort of filtering or upfront categorization search where renters would need to know in advance what's important to them. These approaches do not take into account the user's payment history and instead put the burden on the renter to determine what's important for them at that particular time. However the renter may have multiple priorities and given the number of listings it may be difficult to simply indicate which priority is the most important, or they're inundated with all the information and it's not tailored to the renter in any way. Also, different regions have different criteria that the renters might not be aware of. For example if a renter is moving to an area where they need to provide their own appliances such as a stove or refrigerator but they're coming from an area where it's typically something that is provided for them, they might not know to indicate that their situation requires them to have or bring a stove or refrigerator. Using automated data reporting service processes such as AI agents, the platform can surface or could anticipate these criteria or highlight to the renter that you would need to provide your own fridge or stove since that might not be something that the landlord would indicate because it's common in that region for landlords to not put that in the listing since it assumed that renters would be bringing that. Similarly some regions may or may not include certain amenities like furnishings.

Through the present platform, as a renter looks for a particular unit the listing would provide the relevant information that the renter would be interested in. This information can be personalized using automated data reporting service processes such as AI agents. If the platform determined that a particular user was a family who had a good rental history and/or income, the system could promote automatically or anticipate or surface to the user listings that better align with the user beyond just the limited search criteria provided by the user. If it is determined that maybe a renter more responsive to listings that had good schools or that were close by parks or libraries because the platform can infer the user's age, education, or some sort of demographic or quality score about the user based on the rental history, the rental history and inferred profile of the renter could be used to tailor a listing information to a user based on their status in life as a family member, head of household, etc.

The merging of the physical and digital worlds, also known as the “convergence” of these worlds, refers to the integration of digital technologies and experiences into the physical world, and vice versa. This merging has been made possible by advances in technologies such as the internet of things (IoT), augmented, virtual and extended reality, and location-based services. Automated data reporting service processes such as AI agents can be used to aggregate information from the physical and virtual locations where such data and experiences are stored or delivered.

The merging of the physical and digital worlds has many potential benefits. For individuals, it can provide new and enhanced ways of interacting with their surroundings, such as through location-based games and virtual experiences. For businesses, it can offer new opportunities for engagement and interaction with customers, such as through location-based marketing and digital storefronts. With automated data reporting service processes such as AI agents and NFTs, businesses can offer NFTs to their users within a specified location, typically geofenced, that serves as a proof of presence. This means that at the time the digital asset or NFT was created for the user, the user was present within that specified location. Since the NFT is an immutable record on the blockchain, it means that the record serves as a proof of physical presence of the user in that location. It will be obvious that the reverse logic is also true: that is, the NFT or digital asset may be offered, minted, transferred or sold to a user if they are absent from a particular location. The NFTs themselves can be based on ERC721, 1155, 998 (composable NFTs), or 4907 (NFT rentals), 4337 (gasless minting), 6551 (tokenbound accounts), or any other standards that may be developed or deployed. NFT standards could also be on any blockchain including but not limited to Ethereum, Polygon, Solana, Base etc. It may be noted that each of these NFTs is further associated with metadata and wallet address of the users prior to the NFT mint or transfer transaction. It is further noted that the metadata may be provided via an interaction with automated data reporting service processes such as AI agents. Accordingly, the NFTB platform provides all the tools and resources to integrate with any location enabled application.

The merging of the physical and digital worlds can also create new challenges and potential risks. For example, the increasing reliance on digital technologies and networks can make individuals and businesses more vulnerable to cyber attacks and data breaches. Additionally, the integration of digital technologies into the physical world can raise ethical and privacy concerns, as individuals may be unaware of the extent to which their activities and behavior are being monitored and tracked. Almost all of this information can be recorded in the form of metadata of an NFT and immutably stored via a blockchain. It is advantageous to use NFTs because NFTs are stored with wallet addresses, which do not compromise the personal information of an individual. With wallet addresses the identity of users can remain anonymous. As such, a user's transactions and interactions need only be mediated by their wallet address and no other personally identifiable information providing users with enhanced privacy. NFTs can optionally be programmed to self-destruct after a period of time when permission expires, or if so called for by an automated data processing reporting service such as an AI agent

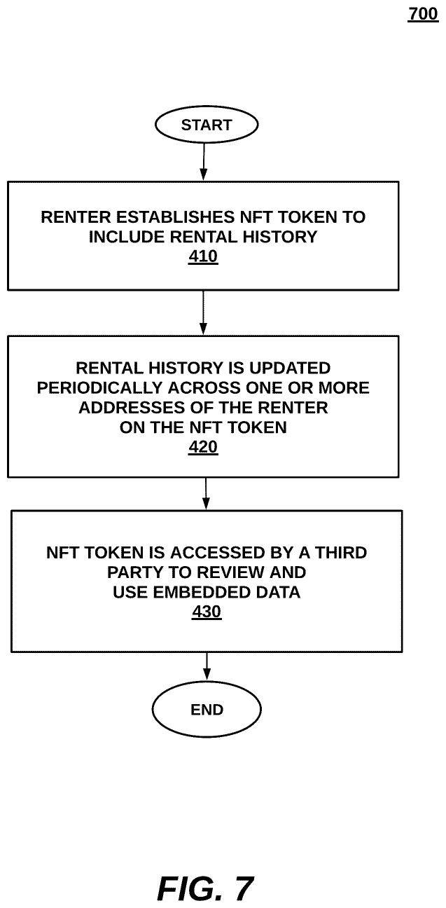

### II. Methods for NFT-Based Rental Certificates (FIG. 7-8)

FIG. 7 is a high-level flow diagram illustrating a method 600.

At step 710, a renter established an NFT token to include rental history and related information. At step 720, the rental history is updated periodically across one or more addresses of the renter on the NFT token. An NFT engine mints NFT tokens and processes and secures transactions. At step 730, the NFT token can be accessed by a third party to review and use embedded data for rental verifications, advertisements, and other purposes.

FIG. 8 is a more detailed diagram illustrating the method 800. At step 810, a renter private key/wallet address pair associated with a specific renter is created to interact with the system. The renter private key/wallet address pair is associated with a specific blockchain.

At step 820, an entity private key/wallet address pair associated with a specific landlord to interact with the smart contract is created. At least a portion of the renter data associated with the specific renter is stored on the blockchain.

At step 830, a smart contract is crated for renter data associated with a relationship between a specific renter and a specific landlord in a rental history database.

At step 840, a new NFT in a series is generated on the specific blockchain according to new rental data using the smart contract and authorized by the entity private key/wallet key pair of the specific renter or the specific landlord to activate the rental history.

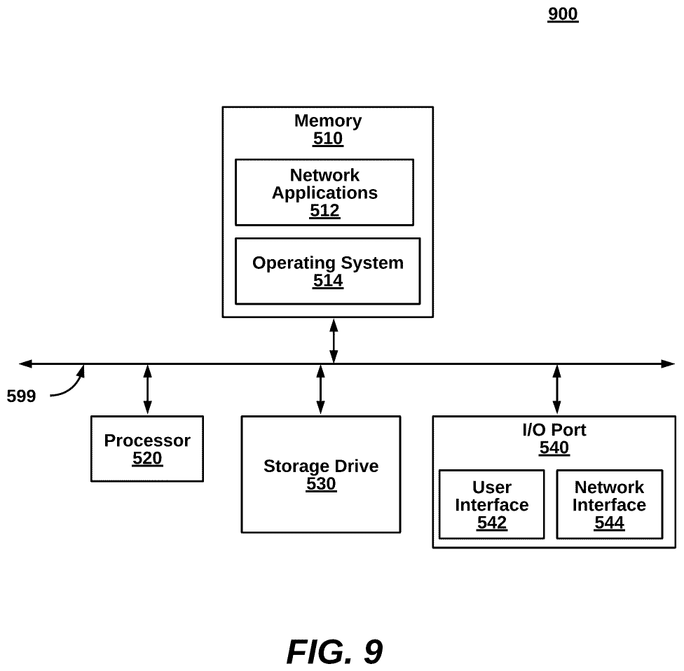

### III. Computing Device for NFT-Backed Rental Certificates (FIG. 9)

FIG. 9 is a block diagram illustrating a computing device 700 for use in the system 100 of FIG. 1, according to one embodiment. The computing device 700 is a non-limiting example device for implementing each of the components of the system 100, including NFT engine 110, rental certificate module 120, renter device 130 and landlord device 140. Additionally, the computing device 500 is merely an example implementation itself, since the system 100 can also be fully or partially implemented with laptop computers, tablet computers, smart cell phones, Internet access applications, and the like.

The computing device 500, of the present embodiment, includes a memory 510, a processor 520, a hard drive 530, and an I/O port 540. Each of the components is coupled for electronic communication via a bus 599. Communication can be digital and/or analog, and use any suitable protocol.

The memory 510 further comprises network access applications 512 and an operating system 514. Network access applications can include 512 a web browser, a mobile access application, an access application that uses networking, a remote access application executing locally, a network protocol access application, a network management access application, a network routing access application, or the like.

The operating system 514 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7-11), Linux, HP-UX, UNIX, Sun OS, Solaris, Mac OS X etc, Alpha OS, AIX, IRIX32, or IRIX84. Other operating systems may be used. Microsoft Windows is a trademark of Microsoft Corporation.

The processor 520 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing element. The processor 520 can be disposed on silicon or any other suitable material. The processor 520 can receive and execute instructions and data stored in the memory 510 or the hard drive 530.

The storage device 530 can be any non-volatile type of storage such as a magnetic disc, EPROM, Flash, or the like. The storage device 530 stores code and data for access applications.

The I/O port 540 further comprises a user interface 742 and a network interface 544. The user interface 542 can output to a display device and receive input from, for example, a keyboard. The network interface 544 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a system, on a data communication network, for providing immutable rental history transactions within a non-fungible cryptographic token (NFT) based rental certificate, the method comprising:
creating a renter private key/wallet address pair associated with a specific renter to interact with the system, wherein the renter private key/wallet address pair is associated with a specific blockchain;
creating an entity private key/wallet address pair associated with a specific landlord to interact with the smart contract and store at least a portion of the renter data associated with the specific renter on the blockchain;
creating a smart contract for renter data associated with a relationship between a specific renter and a specific landlord in a rental history database; and
generating a new NFT in a series on the specific blockchain according to new rental data using the smart contract and authorized by the entity private key/wallet key pair of the specific renter or the specific landlord to activate the rental history.

2. The method of claim 1, further comprising taking an action, responsive to combined rental data of the series of NFTs.

3. The method of claim 1, further comprising minting an NFC certificate based on immutable rental history transactions.

4. The method of claim 1, further comprising periodically updating at least one of a tenant assessments log and a tenant complaints log on the blockchain.

5. The method of claim 1, wherein a plurality of NFT representing different sets of metadata are created.

6. The method of claim 1, further comprising periodically updating a rental payment history on the blockchain.

7. The method of claim 1, further comprising storing the NFT in a wallet.

8. The method of claim 1 where the extraction is done via an AI agent.

9. The method of claim 1 where the private key/wallet pair is the renter private key/wallet key pair.

10. The method of claim 1 where the private key/wallet pair is the entity private key/wallet key pair.

11. The method of claim 1 where the private key/wallet pair is any private key/wallet key pair.

12. The method of claim 1, where the any private key/wallet pair is authorized to interact with the smart contract.

13. The method of claim 1, wherein during the step of creating the NFT further comprises paying a transaction fee is by the user of the private key/wallet pair.

14. The method of claim 1, wherein during the step of creating the NFT, a transaction fee is paid by the entity private key/wallet pair.

15. The method of claim 1, wherein during the step of creating a non-fungible token, a transaction fee is paid by a third party private key/wallet pair.

16. The method of claim 15, wherein the transaction fee is sponsored by a second entity with a second entity private key/wallet pair.

17. The method of claim 1, wherein the specified blockchain address is the user private key/wallet address.

18. The method of claim 1, wherein the specified blockchain address is the entity private key/wallet address.

19. The method of claim 1, wherein the specified blockchain address is a smart wallet.

20. The method of claim 19, wherein the smart wallet is a smart contract deployed to the blockchain, capable of storing fungible or NFTs.

21. The method of claim 19, wherein the smart wallet is a smart contract of the type token bound account, deployed to the blockchain.

22. A non-transitory computer-readable medium in a rental verification system, on a data communication network, storing code that when executed, performs a method for providing immutable rental history transactions within a non-fungible cryptographic token (NFT) based rental certificate, the method comprising:
creating a renter private key/wallet address pair associated with a specific renter to interact with the system, wherein the renter private key/wallet address pair is associated with a specific blockchain;
creating an entity private key/wallet address pair associated with a specific landlord to interact with the smart contract and store at least a portion of the renter data associated with the specific renter on the blockchain;
creating a smart contract for renter data associated with a relationship between a specific renter and a specific landlord in a rental history database; and
generating a new NFT in a series on the specific blockchain according to new rental data using the smart contract and authorized by the entity private key/wallet key pair of the specific renter or the specific landlord to activate the rental history.

23. A rental verification system, on a data communication network, for providing immutable rental history transactions within a non-fungible cryptographic token (NFT) based rental certificate, the rental verification system comprising:
a processor;
a network interface communicatively coupled to the processor and to a data communication network; and
a memory, communicatively coupled to the processor and storing:
a first module to create a renter private key/wallet address pair associated with a specific renter to interact with the system, wherein the renter private key/wallet address pair is associated with a specific blockchain;
a second module to create an entity private key/wallet address pair associated with a specific landlord to interact with the smart contract and store at least a portion of the renter data associated with the specific renter on the blockchain;
a third module to create a smart contract for renter data associated with a relationship between a specific renter and a specific landlord in a rental history database; and
a fourth module to generate a new NFT in a series on the specific blockchain according to new rental data using the smart contract and authorized by the entity private key/wallet key pair of the specific renter or the specific landlord to activate the rental history.
